(19) United States
(12) Patent Application Publication
(10) Pub. No.: US 2026/0177472 A1
(43) Pub. Date: Jun. 25, 2026

(54) SIMULATION SYSTEM AND SIMULATION TEST METHOD FOR ROCK WEATHERING IN EXTREME ENVIRONMENT OF MARS

(71) Applicant: Institute of Rock and Soil Mechanics, Chinese Academy of Sciences, Wuhan (CN)

(72) Inventors: Pengzhi PAN, Wuhan (CN); Yage WANG, Wuhan (CN); Yujie FENG, Wuhan (CN); Xuhai TANG, Wuhan (CN); Haifeng ZHAO, Wuhan (CN); Xufeng LIU, Wuhan (CN)

(73) Assignee: Institute of Rock and Soil Mechanics, Chinese Academy of Sciences, Wuhan (CN)

(21) Appl. No.: 19/370,779

(22) Filed: Oct. 28, 2025

(30) Foreign Application Priority Data
Dec. 20, 2024 (CN) 2024118895683

(51) Int. Cl. G01N 17/00

(52) U.S. Cl. CPC G01N 17/002

(57) ABSTRACT

This disclosure discloses a simulation system for rock weathering in an extreme environment of Mars. The simulation system for rock weathering in an extreme environment of Mars includes a vacuum chamber, a storage structure, a temperature simulation unit, a gas circulation simulation unit, a wind speed simulation unit, and an illumination simulation unit. This disclosure further discloses a simulation test method for rock weathering in an extreme environment of Mars. Compared with the prior art, the simulation system for rock weathering in an extreme environment of Mars prepared by this disclosure can synchronously simulate extreme environments such as a vacuum environment, an atmospheric environment, a temperature environment, an illumination environment, and a sand and dust environment on a surface of Mars, monitors changes such as mass, porosity, and surface deformation of the sample in the weathering process in the extreme environment of Mars of the simulation system.

### CROSS-REFERENCE TO RELATED APPLICATIONS

The application claims priority to Chinese patent application No. 2024118895683, filed on Dec. 20, 2024, the entire contents of which are incorporated herein by reference.

### TECHNICAL FIELD

This disclosure relates to the field of rock physical and mechanical properties testing in an extreme environment, and in particular, to a simulation system and a simulation test method for rock weathering in an extreme environment of Mars.

### BACKGROUND

Mars is the planet most similar to Earth among near-Earth planets. Scientific research on Mars can help better understand the early evolutionary history and the origin of life of Earth. Meanwhile, the rock and soil materials on the surface of Mars are important record carriers for the geological evolution history of Mars. Research is carried out on the rock and soil material on the surface of Mars by using relevant knowledge of the known surface natural environment, and a corresponding ground similarity simulation is established, which has a significant scientific research value for better understanding of the evolution of Mars. The average atmospheric pressure on Mars is 0.75 kPa; the atmosphere is mainly composed of carbon dioxide, accounting for 95%; the average surface temperature ranges from −130° C. to 20° C.; the extreme wind speed is 150 m/s; the main surface terrain is a wind-eroded desert landform; the gravitational acceleration is 3.72 m/s²; and the average irradiance is 589 W/m².

Most existing related technologies focus on simulating the surface environment of Mars. By comprehensively considering the effect of low-pressure thermal environment and wind speed of Mars, various components cooperate with each other to successfully reproduce the unique low-pressure thermal environment of Mars. However, current research is relatively insufficient regarding the specific changes that rock materials undergo after long-term exposure to extreme conditions like those on Mars, especially the question of how they are affected by weathering.

Therefore, how to provide a simulation system for rock weathering in an extreme environment of Mars that can conduct research specifically on the weathering characteristics of a rock sample in the extreme environment of Mars to achieve the technical effect of synchronous simulation of extreme environments such as a vacuum environment, an atmospheric environment, a temperature environment, an illumination environment, and a sand and dust environment on a surface of Mars, is a technical problem that needs to be urgently solved by those skilled in the art.

### SUMMARY

In view of problems existing in the prior art, the technical problem to be solved by this disclosure is to provide a more comprehensive simulation system and evaluation method to conduct research specifically on weathering characteristics of rock samples in the extreme environment of Mars, so that the simulation system achieves synchronous simulation of extreme environments such as a vacuum environment, an atmospheric environment, a temperature environment, an illumination environment, and a sand and dust environment on a surface of the Mars, and performs a systematic assessment on the weathering characteristics of the rock by analyzing changes in physical and mechanical properties of the rock before and after the rock is subjected to the extreme environment of Mars.

To achieve the above objective, this disclosure provides a simulation system for rock weathering in an extreme environment of Mars. The simulation system for rock weathering in an extreme environment of Mars includes: a vacuum chamber, where the vacuum chamber includes a vacuum chamber body and a vacuum chamber cover, the vacuum chamber body is of a cubic box structure, and the vacuum chamber cover is located at the top of the vacuum chamber body and is connected to the vacuum chamber body in a sealed manner; a storage structure, where the storage structure is located in the vacuum chamber body, the storage structure includes an object carrying platform and a storage tray, the object carrying platform is located on a bottom surface of the vacuum chamber body, the storage tray is located on the object carrying platform, and a sample is located in the storage tray; a temperature simulation unit, where the temperature simulation unit is used for controlling a temperature inside the vacuum chamber; a gas circulation simulation unit, where the gas circulation simulation unit includes a gas inflation structure and a gas extraction structure, the gas inflation structure is used for filling carbon dioxide gas, methane gas, and nitrogen gas into the interior of the vacuum chamber, and the gas extraction structure is used for vacuumizing the interior of the vacuum chamber; a wind speed simulation unit, where the wind speed simulation unit is used for controlling a sand and dust phenomenon inside the vacuum chamber; and an illumination simulation unit, where the illumination simulation unit is disposed on an upper portion of one side of an inner side wall of the vacuum chamber body, the illumination simulation unit includes a spectrometer and an ultraviolet irradiation light source, the ultraviolet irradiation light source is located above the spectrometer, and the ultraviolet irradiation light source is connected to the spectrometer.

In the first aspect, the temperature simulation unit includes: a soil bin, the soil bin being of a circular ring structure, the soil bin being located on the object carrying platform, and the soil bin being covered on an outer side of the storage tray; and an infrared heating cage, the infrared heating cage being of a cubic box structure, an opening end of the infrared heating cage being located on the object carrying platform, and the infrared heating cage being covered on a periphery of the soil bin.

In the first aspect, the simulation system for rock weathering in an extreme environment of Mars further includes a measurement unit and a numerical control terminal, where the measurement unit includes: a vacuum gauge, a probe of the vacuum gauge being located inside the vacuum chamber; a gas detector, a probe of the gas detector being located inside the vacuum chamber; a pressure sensor, the pressure sensor being disposed at the bottom of the storage tray; a PIV system, the PIV system being disposed closely adjacent to an inner side wall of the soil bin; a high-precision industrial camera, the high-precision industrial camera being located on an inner side of the soil bin, and the high-precision industrial camera being disposed on one side of the PIV system; a temperature sensor, the temperature sensor being located on the inner side of the soil bin, and the temperature sensor being disposed on one side, away from the PIV system, of the high-precision industrial camera; and a temperature controller, the temperature controller being connected to the temperature sensor, where the storage tray is located between the PIV system and the high-precision industrial camera; the temperature controller is connected to the infrared heating cage; and a data output end of the vacuum gauge, a data output end of the gas detector, the pressure sensor, the PIV system, the high-precision industrial camera, the temperature controller, and the spectrometer are all connected to the numerical control terminal.

In the first aspect, the temperature simulation unit further includes: a liquid nitrogen storage tank; a heat sink pipe, the heat sink pipe being disposed around an inner periphery of the vacuum chamber body; two liquid nitrogen pipes, one end of one liquid nitrogen pipe being fixedly connected to an output end of the liquid nitrogen storage tank, the other end of one liquid nitrogen pipe being fixedly connected to one end of the heat sink pipe through a first flange, one end of the other liquid nitrogen pipe being fixedly connected to an input end of the liquid nitrogen storage tank, and the other end of the other liquid nitrogen pipe being fixedly connected to the other end of the heat sink pipe through a second flange; two liquid nitrogen control valves, one of the liquid nitrogen control valves being disposed at one end, close to the liquid nitrogen storage tank, of one liquid nitrogen pipe, and the other liquid nitrogen control valve being disposed at one end, close to the liquid nitrogen storage tank, of the other liquid nitrogen pipe; and a first cold trap, the first cold trap being disposed on the other liquid nitrogen pipe, and the first cold trap being located between the other liquid nitrogen control valve and the second flange.

In the first aspect, the gas inflation structure includes: a CH₄ gas cylinder; a first gas delivery pipe, one end of the first gas delivery pipe being connected to an output end of the CH₄ gas cylinder; an N₂ gas cylinder; a second gas delivery pipe, one end of the second gas delivery pipe being connected to an output end of the N₂ gas cylinder, and the other end of the second gas delivery pipe being connected to the other end of the first gas delivery pipe; a third gas delivery pipe, one end of the third gas delivery pipe being connected to a connecting end of the first gas delivery pipe and the second gas delivery pipe; a CO₂ gas cylinder; a fourth gas delivery pipe, one end of the fourth gas delivery pipe being connected to an output end of the CO₂ gas cylinder, and the other end of the fourth gas delivery pipe being connected to the other end of the third gas delivery pipe; a fifth gas delivery pipe, one end of the fifth gas delivery pipe being connected to a connecting end of the third gas delivery pipe and the fourth gas delivery pipe, and the other end of the fifth gas delivery pipe being connected to the wind speed simulation unit through a third flange; four gas delivery control valves, the first gas delivery control valve being disposed on the first gas delivery pipe, the second gas delivery control valve being disposed on the third gas delivery pipe, the third gas delivery control valve being disposed on the fourth gas delivery pipe, and the fourth gas delivery control valve being disposed on the fifth gas delivery pipe; three mass flowmeters, the first mass flowmeter being disposed on an output side of the first gas delivery control valve on the first gas delivery pipe, the second mass flowmeter being disposed on an output side of the second gas delivery control valve on the third gas delivery pipe, and the third mass flowmeter being disposed on an output side of the third gas delivery control valve on the fourth gas delivery pipe; and a second cold trap, the second cold trap being disposed on an output side of the fourth gas delivery control valve on the fifth gas delivery pipe.

In the first aspect, the gas extraction structure includes: a vacuum pump; a gas extraction pipe, one end of the gas extraction pipe being connected to the vacuum pump, and the other end of the gas extraction pipe being connected to the vacuum chamber body through a fourth flange; a gas extraction control valve, the gas extraction control valve being disposed on the gas extraction pipe; and a third cold trap, the third cold trap being disposed between the fourth flange and the gas extraction control valve.

In the first aspect, the wind speed simulation unit includes: a high-pressure gas tank; a sand storage tank, one end of the sand storage tank being connected to the high-pressure gas tank through a sand blowing pipe; a sixth gas delivery pipe, one end of the sixth gas delivery pipe being connected to the other end of the sand storage tank, the other end of the sixth gas delivery pipe being connected to the fifth gas delivery pipe, a connecting end of the sixth gas delivery pipe and the fifth gas delivery pipe being located between the fourth control valve and the second cold trap, and the sixth gas delivery pipe being provided with a fifth control valve; and a fan, an air outlet of the fan being provided with a filter screen, and the fan being arranged on an upper portion of an inner side wall of the vacuum chamber body; where the other end of the fifth gas delivery pipe is connected to an air inlet of the fan through the third flange, and the fan is connected to the numerical control terminal.

This disclosure further provides a simulation test method for rock weathering in an extreme environment of Mars, and the simulation test method is used in the above simulation system for rock weathering in an extreme environment of Mars. The simulation method for rock weathering in an extreme environment of Mars includes: placing a sample on a storage tray inside the soil bin, covering a vacuum chamber cover, and monitoring the mass of the sample in real time through a pressure sensor; and opening a high-precision industrial camera to align with the sample; opening a vacuum pump to stabilize air pressure in a vacuum chamber at 0.75 kPa, opening a CO₂ gas cylinder and a fan, and observing a CO₂ content monitored by a gas detector until the monitored CO₂ content is stably maintained at 95%; and then simultaneously opening an N₂ gas cylinder and a CH₄ gas cylinder, keeping the CO₂ content unchanged, and allowing an N₂ content to be 3% and a CH₄ content to be a trace amount, so as to simulate atmospheric composition on a surface of Mars; opening a liquid nitrogen storage tank and a liquid nitrogen control valve to convey liquid nitrogen into a heat sink pipe, allowing a temperature in the vacuum chamber to reduce to −130° C.; turning on an ultraviolet irradiation light source and a spectrometer, and controlling the spectrometer to adjust the irradiance of the ultraviolet irradiation light source, so as to simulate a situation that the surface of Mars is irradiated by Sun; opening a high-pressure gas tank and a fifth control valve to allow a gas discharged from the high-pressure gas tank to carry out of silicon dioxide particles in a sand storage tank to form a dust-containing gas, and allow the dust-containing gas to pass through the fan to form a wind velocity field, so as to simulate a sand and dust phenomenon on the surface of Mars; monitoring a flow velocity field in the vacuum chamber in real time through a PIV system; and performing weathering characteristics assessment on the sample after a weathering simulation is completed.

In the second aspect, the simulation method for rock weathering in an extreme environment of Mars further includes: performing drying and CT scanning processing on the sample before performing the weathering simulation to obtain porosity no and density of the sample in an initial state, performing speckle spraying on a surface of the sample at the same time, ensuring uniform speckle distribution, and using the high-precision industrial camera to capture an initial picture of the sample.

In the second aspect, after the weathering simulation is completed, the weathering characteristics assessment of the sample includes: taking initial mass m₀ and final mass m₁ of the sample based on the mass of the sample monitored in real time by the pressure sensor, and performing CT scanning on the sample after the weathering simulation is completed to obtain final porosity n₁ and density of the sample; analyzing a displacement variation Δdᵢ of each speckle point on the surface of the sample after the weathering simulation is completed by using a distribution change of each speckle in the sample monitored in real time by the high-precision industrial camera presented by a numerical control terminal, combined with initial picture data of the sample, where i is an integer and ranges from 1 to 200; calculating a mass loss rate Δm, a porosity change rate Δn and a surface deformation coefficient & of the sample, where the mass loss rate of the sample: Δm=(m₀−m₁)/m₀×100%, the porosity change rate of the sample: Δn=(n₀−n₁)/n₀×100%, and the surface deformation coefficient of the sample:

$$ε = \sqrt{{{Σ}_{i = 1}^{a} ( Δ {d}_{i} )}^{2} / a} ,$$

where Δdᵢ is a displacement variation of the i^{th} point of the surface of the sample, a is the number of speckles, and a=200; and assigning a weight coefficient, taking a mass weight coefficient w₁ as 0.25, a porosity weight coefficient w₂ as 0.25, and a surface deformation weight coefficient w₃ as 0.5; and proposing a weathering index p, and p=w₁|Δm|+w₂|Δn|+w₃ε, where the larger p value indicates the higher degree of weathering of the sample in a rock weathering system in an extreme environment of Mars.

### Beneficial Effects

The simulation system for rock weathering in an extreme environment of Mars of this disclosure is used for synchronously simulating extreme environments such as a vacuum environment, an atmospheric environment, a temperature environment, an illumination environment, and a sand and dust environment on a surface of Mars. An internal space of the vacuum chamber is sealed and is composed of the vacuum chamber body and the vacuum chamber cover. The vacuum chamber cover is provided with a dynamic seal, so that the vacuum chamber cover is connected to a top opening of the vacuum chamber body in a sealed manner. An observation port is formed in a side wall of the vacuum chamber body, and the observation port is provided with an observation window, which facilitates observing the overall macroscopic condition of the interior of the vacuum chamber. The object carrying platform is placed at the bottom of the vacuum chamber body, and two bottom pillars are connected to a lower end surface of the object carrying platform for being placed at the bottom of the vacuum chamber body arranged with the heat sink pipe. The temperature simulation unit is used for simulating the extreme temperature on the surface of Mars in the vacuum chamber. The gas circulation simulation unit is used for simulating the air composition on the surface of Mars. The wind speed simulation unit is used for simulating the wind and dust phenomenon on the surface of Mars in the vacuum chamber. The illumination simulation unit is used for simulating the irradiation on the surface of Mars through the spectrometer and the ultraviolet irradiation light source, controlling the irradiance at 589 W/m². In conclusion, the simulation system for rock weathering in an extreme environment of Mars of this disclosure can synchronously simulate extreme environments such as a vacuum environment, an atmospheric environment, a temperature environment, an illumination environment, and a sand and dust environment on a surface of Mars.

### BRIEF DESCRIPTION OF THE DRAWINGS

To illustrate the technical solutions in the embodiments of this disclosure or in the prior art more clearly, the following briefly introduces the accompanying drawings to be used for describing the embodiments. Obviously, the accompanying drawings in the following description only show some embodiments of this disclosure, and those of ordinary skill in the art may still derive other accompanying drawings from these accompanying drawings without creative efforts.

FIGURE is a schematic structural diagram of a simulation system for rock weathering in an extreme environment of Mars according to this disclosure.

### REFERENCE NUMERALS

11. vacuum chamber body; 12. vacuum chamber cover; 13. observation window;
21. object carrying platform; 22. storage tray;
31. gas inflation structure; 311. CH₄ gas cylinder; 312. N₂ gas cylinder; 313. CO₂ gas cylinder; 314. gas delivery control valve; 315. second cold trap; 32. gas extraction structure; 321. vacuum pump; 322. gas extraction pipe; 323. gas extraction control valve; 324. third cold trap;
41. spectrometer; 42. ultraviolet irradiation light source;
51. soil bin; 52. infrared heating cage; 53. liquid nitrogen storage tank; 54. heat sink pipe; 55. liquid nitrogen pipe; 56. liquid nitrogen control valve; 57. first cold trap;
61. vacuum gauge; 62. gas detector; 63. pressure sensor; 64. PIV system; 65. high-precision industrial camera; 66. temperature sensor; 67. temperature controller;
71. high-pressure gas tank; 72. sand storage tank; 73. sixth gas delivery pipe; 74. fan;
81. numerical control terminal;
101. sample.

### DETAILED DESCRIPTION OF THE EMBODIMENTS

The technical solutions in the embodiments of this disclosure are clearly and completely described below with reference to the accompanying drawings in the embodiments of this disclosure. Obviously, the described embodiments are only some but not all of the embodiments of this disclosure. All other embodiments obtained by those of ordinary skill in the art based on the embodiments of the specification shall fall within the protection scope of this disclosure.

### Embodiment 1

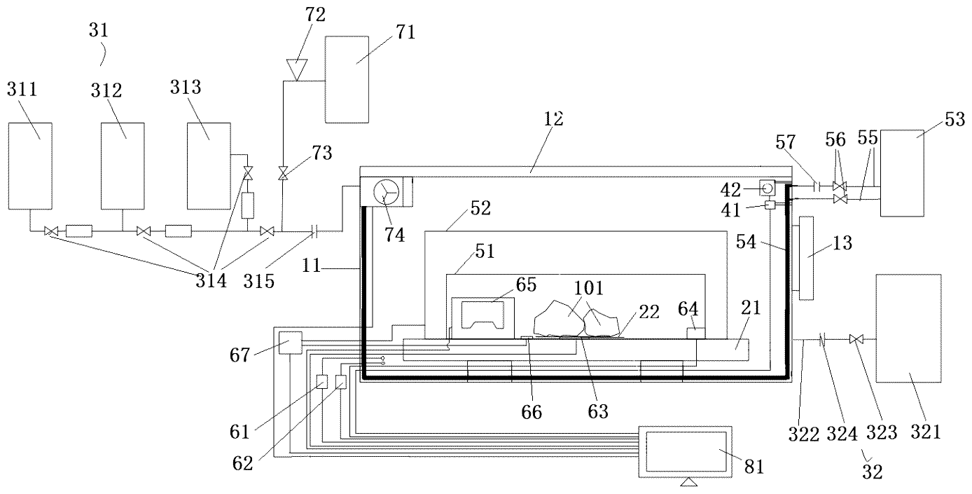

As shown in FIG. 1, Embodiment 1 provides a simulation system for rock weathering in an extreme environment of Mars. The simulation system for rock weathering in an extreme environment of Mars includes: a vacuum chamber, where the vacuum chamber includes a vacuum chamber body 11 and a vacuum chamber cover 12, the vacuum chamber body 11 is of a cubic box structure, and the vacuum chamber cover 12 is located at the top of the vacuum chamber body 11 and is connected to the vacuum chamber body 11 in a sealed manner; a storage structure, where the storage structure is located in the vacuum chamber body 11, the storage structure includes an object carrying platform 21 and a storage tray 22, the object carrying platform 21 is located on a bottom surface of the vacuum chamber body 11, the storage tray 22 is located on the object carrying platform 21, and a sample 101 is located in the storage tray 22; a temperature simulation unit, where the temperature simulation unit is used for controlling a temperature inside the vacuum chamber; a gas circulation simulation unit, where the gas circulation simulation unit includes a gas inflation structure 31 and a gas extraction structure 32, the gas inflation structure 31 is used for filling carbon dioxide gas, methane gas, and nitrogen gas into the interior of the vacuum chamber, and the gas extraction structure 32 is used for vacuumizing the interior of the vacuum chamber; a wind speed simulation unit, where the wind speed simulation unit is used for controlling a sand and dust phenomenon inside the vacuum chamber; and an illumination simulation unit, where the illumination simulation unit is disposed on an upper portion of one side of an inner side wall of the vacuum chamber body 11, the illumination simulation unit includes a spectrometer 41 and an ultraviolet irradiation light source 42, the ultraviolet irradiation light source 42 is located above the spectrometer 41, and the ultraviolet irradiation light source 42 is connected to the spectrometer 41.

The simulation system for rock weathering in an extreme environment of Mars of this disclosure is used for synchronously simulating extreme environments such as a vacuum environment, an atmospheric environment, a temperature environment, an illumination environment, and a sand and dust environment on a surface of Mars. An internal space of the vacuum chamber is sealed and is composed of the vacuum chamber body 11 and the vacuum chamber cover 12. The vacuum chamber cover 12 is provided with a dynamic seal, so that the vacuum chamber cover 12 is connected to a top opening of the vacuum chamber body 11 in a sealed manner. An observation port is formed in a side wall of the vacuum chamber body 11, and the observation port is provided with an observation window 13, which facilitates observing the overall macroscopic condition of the interior of the vacuum chamber. The object carrying platform 21 is placed at the bottom of the vacuum chamber body 11, and two bottom pillars are connected to a lower end surface of the object carrying platform 21 for being placed at the bottom of the vacuum chamber body 11 arranged with the heat sink pipe 54. The temperature simulation unit is used for simulating the extreme temperature on the surface of Mars in the vacuum chamber. The gas circulation simulation unit is used for simulating the air composition on the surface of Mars. The wind speed simulation unit is used for simulating the wind and dust phenomenon on the surface of Mars in the vacuum chamber. The illumination simulation unit is used for simulating the irradiation on the surface of Mars through the spectrometer 41 and the ultraviolet irradiation light source 42, controlling the irradiance at 589 W/m². In conclusion, the simulation system for rock weathering in an extreme environment of Mars of this disclosure can synchronously simulate extreme environments such as a vacuum environment, an atmospheric environment, a temperature environment, an illumination environment, and a sand and dust environment on a surface of Mars.

In some possible implementations, the temperature simulation unit includes: a soil bin 51, the soil bin 51 being of a circular ring structure, the soil bin 51 being located on object carrying platform, and the soil bin 51 being covered on an outer side of the storage tray 22; and an infrared heating cage 52, the infrared heating cage 52 being of a cubic box structure, an opening end of the infrared heating cage 52 being located on the object carrying platform, and the infrared heating cage 52 being covered on a periphery of the soil bin 51.

Specifically, an inner side of the soil bin 51 is used for placing the storage tray 22 to place the sample 101. A plurality of samples 101 are placed on the storage tray 22, and each sample 101 has a different natural shape, and surface roughness of each sample 101 is different. Meanwhile, the average density of the plurality of samples 101 is about 3 g/cm³, and the sample 101 is suspended with basalt having a particle size in a range of 2-10 mm. A test is performed by using basalt having different surface roughness to better simulate the weathering process, thereby achieving an ideal effect. The infrared heating cage 52 is connected to the temperature controller 67, and the temperature adjustment of the infrared heating cage 52 is controlled by the temperature controller 67. Both the infrared heating cage 52 and the soil bin 51 are made of stainless steel, which has good high-temperature resistance.

In some possible implementations, the simulation system for rock weathering in an extreme environment of Mars further includes: a measurement unit and a numerical control terminal 81, where the measurement unit includes: a vacuum gauge 61, a probe of the vacuum gauge 61 being located inside the vacuum chamber; a gas detector 62, a probe of the gas detector 62 being located inside the vacuum chamber; a pressure sensor 63, the pressure sensor 63 being disposed at the bottom of the storage tray 22; a PIV system 64, the PIV system 64 being disposed closely adjacent to an inner side wall of the soil bin 51; a high-precision industrial camera 65, the high-precision industrial camera 65 being located on an inner side of the soil bin 51, and the high-precision industrial camera 65 being disposed on one side of the PIV system 64; a temperature sensor 66, the temperature sensor 66 being located on the inner side of the soil bin 51, and the temperature sensor 66 being disposed on one side, away from the PIV system 64, of the high-precision industrial camera 65; and a temperature controller 67, the temperature controller 67 being connected to the temperature sensor 66, where the storage tray 22 is located between the PIV system 64 and the high-precision industrial camera 65; the temperature controller 67 is connected to the infrared heating cage 52; and a data output end of the vacuum gauge 61, a data output end of the gas detector 62, the pressure sensor 63, the PIV system 64, the high-precision industrial camera 65, the temperature controller 67, and the spectrometer 41 are all connected to the numerical control terminal 81.

Specifically, the vacuum gauge 61 is used for monitoring the pressure in the vacuum chamber, and the gas detector 62 is used for detecting the gas content inside the vacuum chamber; the pressure sensor 63 is used for monitoring the mass of the sample 101 in the storage tray 22 in real time; the PIV system 64 is used for measuring the velocity distribution of the entire flow field within the vacuum chamber and providing high-resolution velocity field data, while visualizing the flow velocity through the numerical control terminal 81; the high-precision industrial camera 65 is used for capturing a sample 101 having a speckle pattern sprayed on the surface, and a strain and a displacement field on the surface of the sample 101 are calculated by comparing the displacement of the speckle pattern on the surface of the sample 101 before and after weathering, that is, the high-precision industrial camera is used for monitoring the variation of the speckle on the surface of the rock sample 101 in real time, so as to measure the deformation field thereof; the temperature sensor 66 is used for monitoring the temperature change in the vacuum chamber in real time, and the temperature sensor 66 is connected to the temperature controller 67 to adjust the temperature inside the vacuum chamber in combination with the infrared heating cage 52; and a cable hole is formed in a side wall of the vacuum chamber body 11, a cable perforator is disposed at the cable hole, the cable perforator is connected to the cable hole in a sealed manner, all cables in the vacuum chamber pass through the cable perforator, and the cable is connected to the cable perforator in a sealed manner, so as to ensure that all cables in the vacuum chamber pass through the cable perforator while ensuring gas tightness in the vacuum chamber.

In some possible implementations, the temperature simulation unit further includes: a liquid nitrogen storage tank 53; a heat sink pipe 54, the heat sink pipe 54 being disposed around an inner periphery of the vacuum chamber body 11; two liquid nitrogen pipes 55, one end of one liquid nitrogen pipe 55 being fixedly connected to an output end of the liquid nitrogen storage tank 53, the other end of one liquid nitrogen pipe 55 being fixedly connected to one end of the heat sink pipe 54 through a first flange, one end of the other liquid nitrogen pipe 55 being fixedly connected to an input end of the liquid nitrogen storage tank 53, and the other end of the other liquid nitrogen pipe 55 being fixedly connected to the other end of the heat sink pipe 54 through a second flange; two liquid nitrogen control valves 56, one of the liquid nitrogen control valves 56 being disposed at one end, close to the liquid nitrogen storage tank 53, of one liquid nitrogen pipe 55, and the other liquid nitrogen control valve 56 being disposed at one end, close to the liquid nitrogen storage tank 53, of the other liquid nitrogen pipe 55; and a first cold trap 57, the first cold trap 57 being disposed on the other liquid nitrogen pipe 55, and the first cold trap 57 being located between the other liquid nitrogen control valve 56 and the second flange.

Specifically, two openings are formed in an upper portion of one inner side wall of the vacuum chamber body 11, the two openings are respectively provided with the first flange and the second flange, so that the liquid nitrogen storage tank 53 is connected to both ends of the heat sink pipe 54 while maintaining the gas tightness in the vacuum chamber. The liquid nitrogen in the liquid nitrogen storage tank 53 is conveyed to the heat sink pipe 54, and the purpose of cooling the interior of the vacuum chamber is achieved through the conveying of liquid nitrogen in the heat sink pipe 54. The flow rate of liquid nitrogen in the heat sink pipe 54 is controlled by the liquid nitrogen control valve 56 at an output end of the liquid nitrogen storage tank 53, so that the liquid nitrogen content in the heat sink is more accurately adjusted according to the temperature change requirements. The heat sink pipe 54 is an integral pipe, which is laid on the bottom surface and left and right sides of the vacuum chamber body 11 to ensure uniform temperature distribution inside the vacuum chamber. After the liquid nitrogen is conveyed from the output end of the liquid nitrogen storage tank 53 into the heat sink pipe 54, the liquid nitrogen flows out through the other end of the heat sink pipe 54 and enters the liquid nitrogen storage tank 53 through the input end of the liquid nitrogen storage tank 53, thus achieving the circulation of liquid nitrogen. The first cold trap 57 is used for condensing the vaporized liquid nitrogen into a liquid. The heat sink pipe 54 is made of aluminum material, which can respond to temperature changes relatively quickly.

In some possible implementations, the gas inflation structure 31 includes: a CH₄ gas cylinder 311; a first gas delivery pipe, one end of the first gas delivery pipe being connected to an output end of the CH₄ gas cylinder 311; an N₂ gas cylinder 312; a second gas delivery pipe, one end of the second gas delivery pipe being connected to an output end of the N₂ gas cylinder 312, and the other end of the second gas delivery pipe being connected to the other end of the first gas delivery pipe; a third gas delivery pipe, one end of the third gas delivery pipe being connected to a connecting end of the first gas delivery pipe and the second gas delivery pipe; a CO₂ gas cylinder 313; a fourth gas delivery pipe, one end of the fourth gas delivery pipe being connected to an output end of the CO₂ gas cylinder 313, and the other end of the fourth gas delivery pipe being connected to the other end of the third gas delivery pipe; a fifth gas delivery pipe, one end of the fifth gas delivery pipe being connected to a connecting end of the third gas delivery pipe and the fourth gas delivery pipe, and the other end of the fifth gas delivery pipe being connected to the wind speed simulation unit through a third flange; four gas delivery control valves 314, the first gas delivery control valve 314 being disposed on the first gas delivery pipe, the second gas delivery control valve 314 being disposed on the third gas delivery pipe, the third gas delivery control valve 314 being disposed on the fourth gas delivery pipe, and the fourth gas delivery control valve 314 being disposed on the fifth gas delivery pipe; three mass flowmeters, the first mass flowmeter being disposed on an output side of the first gas delivery control valve 314 on the first gas delivery pipe, the second mass flowmeter being disposed on an output side of the second gas delivery control valve 314 on the third gas delivery pipe, and the third mass flowmeter being disposed on an output side of the third gas delivery control valve 314 on the fourth gas delivery pipe; and a second cold trap 315, the second cold trap 315 being disposed on an output side of the fourth gas delivery control valve 314 on the fifth gas delivery pipe.

Specifically, the CO₂ gas cylinder 313, the N₂ gas cylinder 312, the CH₄ gas cylinder 311 are respectively disposed in different branches, and each branch is provided with a respective control valve and mass flowmeter. During gas inflation, CO₂, N₂, and CH₄ gases are introduced into the vacuum chamber by opening the CO₂ gas cylinder 313, the N₂ gas cylinder 312, and the CH₄ gas cylinder 311, and the gas delivery control valves 314 corresponding to each gas cylinder, so as to simulate the gas composition and content on the surface of Mars. When the contents of CO₂, N₂, and CH₄ gases in the vacuum chamber meet the requirements, the corresponding gas delivery control valve 314 and the fourth gas delivery control valve 314 are closed to ensure the stability of the gas content in the chamber body. The respective mass flowmeter and gas delivery control valve 314 of each gas cylinder facilitate independent and convenient adjustment of the inflation volume of each gas.

In some possible implementations, the gas extraction structure 32 includes: a vacuum pump 321; a gas extraction pipe 322, one end of the gas extraction pipe 322 being connected to the vacuum pump 321, and the other end of the gas extraction pipe 322 being connected to the vacuum chamber body 11 through a fourth flange; a gas extraction control valve 323, the gas extraction control valve 323 being disposed on the gas extraction pipe 322; and a third cold trap 324, the third cold trap 324 being disposed between the fourth flange and the gas extraction control valve 323.

Specifically, a gas extraction hole is formed in one inner side wall of the vacuum chamber body 11, and the fourth flange is disposed at the gas extraction hole, so that the gas extraction pipe 322 is in communication with the interior of the vacuum chamber, and the gas tightness inside the vacuum chamber is ensured. During gas extraction, the gas in the vacuum chamber first passes through the third cold trap 324 to capture volatile substances and solid particles or liquid, and then enters the vacuum pump 321, thereby reducing harmful substances entering the pump and protecting the vacuum pump 321.

In some possible implementations, the wind speed simulation unit includes: a high-pressure gas tank 71; a sand storage tank 72, one end of the sand storage tank 72 being connected to the high-pressure gas tank 71 through a sand blowing pipe; a sixth gas delivery pipe 73, one end of the sixth gas delivery pipe 73 being connected to the other end of the sand storage tank 72, the other end of the sixth gas delivery pipe 73 being connected to the fifth gas delivery pipe, a connecting end of the sixth gas delivery pipe 73 and the fifth gas delivery pipe being located between the fourth control valve and the second cold trap 315, and the sixth gas delivery pipe 73 being provided with a fifth control valve; and a fan 74, an air outlet of the fan 74 being provided with a filter screen, and the fan 74 being arranged on an upper portion of an inner side wall of the vacuum chamber body 11; where the other end of the fifth gas delivery pipe is connected to an air inlet of the fan 74 through the third flange, and the fan 74 is connected to the numerical control terminal 81.

Specifically, the fan 74 can simulate a fixed wind speed, and the variation range of the wind speed is controlled to be 0 m/s-20 m/s. The liquid CO₂ in the high-pressure gas tank 71 is pressed out of the tank, and the liquid CO₂ is rapidly converted into gaseous CO₂ due to changes in pressure and temperature. The CO₂ gas enters the sand storage tank 72 and is mixed with SiO₂ particles flowing out of the sand storage tank 72 into a dust-containing gas. The gas passes through a transportation pipeline and is conveyed into the vacuum chamber body 11 by the fan 74, which well simulates the sand and dust phenomenon on the surface of Mars. In addition, the filter screen is arranged in front of the fan 74, so as to prevent large sand and stone particles from entering the vacuum chamber and causing irreversible damage to experimental instruments. When CO₂, N₂, CH₄ gases are conveyed into the vacuum chamber, the fan 74 needs to be turned on.

### Embodiment 2

As shown in FIG. 1, Embodiment 2 of this disclosure provides a simulation test method for rock weathering in an extreme environment of Mars, and the simulation test method is used for a simulation test of the simulation system for rock weathering in an extreme environment of Mars according to Embodiment 1. The simulation test method for rock weathering in an extreme environment of Mars includes: placing a sample 101 on a storage tray 22 inside the soil bin 51, covering a vacuum chamber cover 12, and monitoring the mass of the sample 101 in real time through a pressure sensor 63; and opening a high-precision industrial camera 65 to align with the sample 101; opening a vacuum pump 321 to stabilize air pressure in a vacuum chamber at 0.75 kPa, opening a CO₂ gas cylinder 313 and a fan 74, and observing a CO₂ content monitored by a gas detector 62 until the monitored CO₂ content is stably maintained at 95%; and then simultaneously opening an N₂ gas cylinder 312 and a CH₄ gas cylinder 311, keeping the CO₂ content unchanged, and allowing an N₂ content to be 3% and a CH₄ content to be a trace amount, so as to simulate atmospheric composition on a surface of Mars; opening a liquid nitrogen storage tank 53 and a liquid nitrogen control valve 56 to convey liquid nitrogen into a heat sink pipe 54, allowing a temperature in the vacuum chamber to reduce to −130° C.; turning on an ultraviolet irradiation light source 42 and a spectrometer 41, and controlling the spectrometer 41 to adjust the irradiance of the ultraviolet irradiation light source 42, so as to simulate a situation that the surface of Mars is irradiated by Sun; opening a high-pressure gas tank 71 and a fifth control valve to allow a gas discharged from the high-pressure gas tank 71 to carry out of silicon dioxide particles in a sand storage tank 72 to form a dust-containing gas, and allow the dust-containing gas to pass through the fan 74 to form a wind velocity field, so as to simulate a sand and dust phenomenon on the surface of Mars; monitoring a flow velocity field in the vacuum chamber in real time through a PIV system 64; and performing weathering characteristics assessment on the sample 101 after a weathering simulation is completed.

Specifically, when opening the corresponding gas cylinder, the gas delivery control valve 314 corresponding to the gas cylinder should also be opened. When opening the N₂ gas cylinder 312 and the CH₄ gas cylinder 311 simultaneously, it should be ensured that the CO₂ gas content is unchanged. Since the N₂ content in the Mars atmosphere is relatively low, accounting for approximately 3%, and the CH₄ content is even more negligible, the CH₄ gas cylinder 311 is first closed to make the CH₄ content less than the N₂ content, and then the N₂ gas cylinder 312 is closed to achieve the purpose of simulating the gas on the surface of Mars. The overall temperature inside the vacuum chamber can be adjusted by controlling the infrared heating cage 52 through the temperature controller 67 and adjusting the liquid nitrogen conveying volume, so that the variation range of the temperature is from −130° C. to 20° C. In the rock weathering simulation of the sample 101 in the extreme environment of Mars, the mass of the sample 101 in the storage tray 22, changes in surface speckle, etc. need to be monitored in real time. In addition, before the weathering simulation test is performed on the sample 101 by using the simulation system for rock weathering in an extreme environment of Mars, it is necessary to check whether all equipment and instruments can operate normally. If all of them can work normally, the vacuum chamber cover 12 is covered, the CO₂ gas cylinder 313 is opened, the CO₂ gas is input into the vacuum chamber body 11, whether gas leakage occurs is detected outside the vacuum chamber body 11, and the gas tightness of the entire device is checked.

It should be noted that the simulation test method for rock weathering in an extreme environment of Mars in Embodiment 2 is used for the simulation test of the simulation system for rock weathering in an extreme environment of Mars according to Embodiment 1. Therefore, the performance principle of the simulation system for rock weathering in an extreme environment of Mars is not repeated herein. For the parts not described in detail, referring to Embodiment 1.

In some possible implementations, the simulation test method for rock weathering in an extreme environment of Mars further includes: performing drying and CT scanning processing on the sample 101 before performing the weathering simulation to obtain porosity n₀ and density of the sample 101 in an initial state, performing speckle spraying on a surface of the sample 101 at the same time, ensuring uniform speckle distribution, and using the high-precision industrial camera 65 to capture an initial picture of the sample 101; and after the weathering simulation is completed, the weathering characteristics assessment of the sample 101 includes: taking initial mass m₀ and final mass m₁ of the sample 101 based on the mass of the sample 101 monitored in real time by the pressure sensor 63, and performing CT scanning on the sample 101 after the weathering simulation is completed to obtain final porosity n₁ and density of the sample 101; analyzing a displacement variation Δdᵢ of each speckle point on the surface of the sample 101 after the weathering simulation is completed by using a distribution change of each speckle in the sample 101 monitored in real time by the high-precision industrial camera 65 presented by a numerical control terminal 81, combined with initial picture data of the sample 101, where i is an integer and ranges from 1 to 200; calculating a mass loss rate Δm, a porosity change rate Δn and a surface deformation coefficient ε of the sample 101, where the mass loss rate of the sample 101: Δm=(m₀−m₁)/m₀×100%, the porosity change rate of the sample 101: Δn=(n₀−n₁)/n₀×100%, and where Δdᵢ is a the surface deformation coefficient of the sample 101:

$$ε = \sqrt{{{Σ}_{i = 1}^{a} ( Δ {d}_{i} )}^{2} / a} ,$$

where ΔDᵢ is a displacement variation of the i^{th} point of the surface of the sample 101, a is the number of speckles, and a=200; and assigning a weight coefficient, taking a mass weight coefficient w₁ as 0.25, a porosity weight coefficient w₂ as 0.25, and a surface deformation weight coefficient w₃ as 0.5; and proposing a weathering index p, and p=w₁|Δm|+w₂|Δn|+w₃ε, where the larger p value indicates the higher degree of weathering of the sample 101 in a rock weathering system in an extreme environment of Mars.

Specifically, a speckle pattern is sprayed on the surface of rock sample 101 before the experiment starts. The high-precision industrial camera 65 is used for capturing rock images in different states, and the strain and the displacement field on the rock surface are calculated by comparing the displacement of speckle pattern in the images taken before and after, that is, the high-precision industrial camera is used for monitoring the variation of the speckle on the surface of the rock sample 101 in real time, so as to measure the deformation field thereof; and the larger p value indicates the higher degree of weathering of the sample 101 in the Mars environment simulation device, and the worse the physical and mechanical properties of the sample 101, which achieves the purpose of evaluating the degree of rock weathering in the Mars environment.

In conclusion, the simulation system for rock weathering in an extreme environment of Mars of this disclosure can achieve synchronous simulation of extreme environments such as a vacuum environment, an atmospheric environment, a temperature environment, an illumination environment, and a sand and dust environment on a surface of the Mars. In addition, a weathering index p of rock in the Mars environment and a calculation method thereof are proposed, which can perform a systematic assessment on the weathering characteristics of rocks in the Mars environment, and has the following advantages: 1. the simulation system for rock weathering in an extreme environment of Mars provided by this disclosure is provided with a CO₂ gas cylinder and a CH₄ gas cylinder, which can truly simulate the atmospheric composition and content on the surface of Mars, meanwhile, CO₂ gas and CH₄ gas also have a certain impact on the weathering effect of the sample, and the provision of the CO₂ gas cylinder and CH₄ gas cylinder can more comprehensively reflect the rock weathering characteristics in the Mars environment; 2. the simulation system for rock weathering in an extreme environment of Mars provided by this disclosure is provided with a high-pressure gas tank and a sand storage tank, which jointly prepare dust-containing gas, so that the sand and dust phenomenon in the Mars environment is better simulated, meanwhile, a filter screen is disposed in front of the fan to filter out larger particles, reducing the impact of sand and dust on the experimental process; 3. in this disclosure, the sample is weathered in the simulation system for rock weathering in an extreme environment of Mars; the systematic assessment is performed on the weathering characteristics of the sample by monitoring changes such as mass, porosity and surface deformation of the sample in the weathering process in the extreme environment of Mars of the simulation system; and the weathering index p and the calculation method thereof are proposed by quantifying the weathering degree of the rock, which helps to better understand a rock weathering mechanism in the Mars environment, enables the weathering degree to be accurately measured and recorded, and improves the comparability of data; 4. the simulation system for rock weathering in an extreme environment of Mars provided by this disclosure is conducive to a deeper understanding of the geological evolution history of Mars, and can also provide valuable technical accumulation and important reference basis for the design and construction of other celestial environment simulation equipment in the future, so as to achieve more accurate reproduction of the unique conditions of various celestial bodies.

The above provides a detailed description of the exemplary embodiments of this disclosure. It should be understood that those skilled in the art can make many modifications and changes according to the concept of this disclosure without creative efforts. Therefore, any technical solution that can be obtained by those skilled in the art according to the concept of this disclosure through logical analysis, logical inference, or limited experiments on the basis of the prior art shall fall within the scope of protection determined by the claims.

What is claimed is:

1. A simulation system for rock weathering in an extreme environment of Mars, wherein the simulation system for rock weathering in an extreme environment of Mars comprises:
a vacuum chamber, wherein the vacuum chamber comprises a vacuum chamber body and a vacuum chamber cover, the vacuum chamber body is of a cubic box structure, and the vacuum chamber cover is located at the top of the vacuum chamber body and is connected to the vacuum chamber body in a sealed manner;
a storage structure, wherein the storage structure is located in the vacuum chamber body, the storage structure comprises an object carrying platform and a storage tray, the object carrying platform is located on a bottom surface of the vacuum chamber body, the storage tray is located on the object carrying platform, and a sample is located in the storage tray;
a temperature simulation unit, wherein the temperature simulation unit is used for controlling a temperature inside the vacuum chamber;
a gas circulation simulation unit, wherein the gas circulation simulation unit comprises a gas inflation structure and a gas extraction structure, the gas inflation structure is used for filling carbon dioxide gas, methane gas, and nitrogen gas into the interior of the vacuum chamber, and the gas extraction structure is used for vacuumizing the interior of the vacuum chamber;
a wind speed simulation unit, wherein the wind speed simulation unit is used for controlling a sand and dust phenomenon inside the vacuum chamber; and
an illumination simulation unit, wherein the illumination simulation unit is disposed on an upper portion of one side of an inner side wall of the vacuum chamber body, the illumination simulation unit comprises a spectrometer and an ultraviolet irradiation light source, the ultraviolet irradiation light source is located above the spectrometer, and the ultraviolet irradiation light source is connected to the spectrometer; wherein
the temperature simulation unit comprises: a soil bin, the soil bin being of a circular ring structure, the soil bin being located on the object carrying platform, and the soil bin being covered on an outer side of the storage tray; and an infrared heating cage, the infrared heating cage being of a cubic box structure, an opening end of the infrared heating cage being located on the object carrying platform, and the infrared heating cage being covered on a periphery of the soil bin;
the simulation system for rock weathering in an extreme environment of Mars further comprises a measurement unit and a numerical control terminal, wherein the measurement unit comprises: a vacuum gauge, a probe of the vacuum gauge being located inside the vacuum chamber; a gas detector, a probe of the gas detector being located inside the vacuum chamber; a pressure sensor, the pressure sensor being disposed at the bottom of the storage tray; a PIV system, the PIV system being disposed closely adjacent to an inner side wall of the soil bin; a high-precision industrial camera, the high-precision industrial camera being located on an inner side of the soil bin, and the high-precision industrial camera being disposed on one side of the PIV system; a temperature sensor, the temperature sensor being located on the inner side of the soil bin, and the temperature sensor being disposed on one side, away from the PIV system, of the high-precision industrial camera; and a temperature controller, the temperature controller being connected to the temperature sensor, wherein the storage tray is located between the PIV system and the high-precision industrial camera; the temperature controller is connected to the infrared heating cage; and a data output end of the vacuum gauge, a data output end of the gas detector, the pressure sensor, the PIV system, the high-precision industrial camera, the temperature controller, and the spectrometer are all connected to the numerical control terminal;
the temperature simulation unit further comprises: a liquid nitrogen storage tank; a heat sink pipe, the heat sink pipe being disposed around an inner periphery of the vacuum chamber body; two liquid nitrogen pipes, one end of one liquid nitrogen pipe being fixedly connected to an output end of the liquid nitrogen storage tank, the other end of one liquid nitrogen pipe being fixedly connected to one end of the heat sink pipe through a first flange, one end of the other liquid nitrogen pipe being fixedly connected to an input end of the liquid nitrogen storage tank, and the other end of the other liquid nitrogen pipe being fixedly connected to the other end of the heat sink pipe through a second flange; two liquid nitrogen control valves, one of the liquid nitrogen control valves being disposed at one end, close to the liquid nitrogen storage tank, of one liquid nitrogen pipe, and the other liquid nitrogen control valve being disposed at one end, close to the liquid nitrogen storage tank, of the other liquid nitrogen pipe; and a first cold trap, the first cold trap being disposed on the other liquid nitrogen pipe, and the first cold trap being located between the other liquid nitrogen control valve and the second flange.

2. The simulation system for rock weathering in an extreme environment of Mars according to claim 1, wherein the gas inflation structure comprises:
a CH₄ gas cylinder;
a first gas delivery pipe, one end of the first gas delivery pipe being connected to an output end of the CH₄ gas cylinder;
an N₂ gas cylinder;
a second gas delivery pipe, one end of the second gas delivery pipe being connected to an output end of the N₂ gas cylinder, and the other end of the second gas delivery pipe being connected to the other end of the first gas delivery pipe;
a third gas delivery pipe, one end of the third gas delivery pipe being connected to a connecting end of the first gas delivery pipe and the second gas delivery pipe;
a CO₂ gas cylinder;
a fourth gas delivery pipe, one end of the fourth gas delivery pipe being connected to an output end of the CO₂ gas cylinder, and the other end of the fourth gas delivery pipe being connected to the other end of the third gas delivery pipe;
a fifth gas delivery pipe, one end of the fifth gas delivery pipe being connected to a connecting end of the third gas delivery pipe and the fourth gas delivery pipe, and the other end of the fifth gas delivery pipe being connected to the wind speed simulation unit through a third flange;
four gas delivery control valves, the first gas delivery control valve being disposed on the first gas delivery pipe, the second gas delivery control valve being disposed on the third gas delivery pipe, the third gas delivery control valve being disposed on the fourth gas delivery pipe, and the fourth gas delivery control valve being disposed on the fifth gas delivery pipe;
three mass flowmeters, the first mass flowmeter being disposed on an output side of the first gas delivery control valve on the first gas delivery pipe, the second mass flowmeter being disposed on an output side of the second gas delivery control valve on the third gas delivery pipe, and the third mass flowmeter being disposed on an output side of the third gas delivery control valve on the fourth gas delivery pipe; and
a second cold trap, the second cold trap being disposed on an output side of the fourth gas delivery control valve on the fifth gas delivery pipe.

3. The simulation system for rock weathering in an extreme environment of Mars according to claim 2, wherein the gas extraction structure comprises:
a vacuum pump;
a gas extraction pipe, one end of the gas extraction pipe being connected to the vacuum pump, and the other end of the gas extraction pipe being connected to the vacuum chamber body through a fourth flange;
a gas extraction control valve, the gas extraction control valve being disposed on the gas extraction pipe; and
a third cold trap, the third cold trap being disposed between the fourth flange and the gas extraction control valve.

4. The simulation system for rock weathering in an extreme environment of Mars according to claim 3, wherein the wind speed simulation unit comprises:
a high-pressure gas tank;
a sand storage tank, one end of the sand storage tank being connected to the high-pressure gas tank through a sand blowing pipe;
a sixth gas delivery pipe, one end of the sixth gas delivery pipe being connected to the other end of the sand storage tank, the other end of the sixth gas delivery pipe being connected to the fifth gas delivery pipe, a connecting end of the sixth gas delivery pipe and the fifth gas delivery pipe being located between the fourth control valve and the second cold trap, and the sixth gas delivery pipe being provided with a fifth control valve; and
a fan, an air outlet of the fan being provided with a filter screen, and the fan being arranged on an upper portion of an inner side wall of the vacuum chamber body; wherein
the other end of the fifth gas delivery pipe is connected to an air inlet of the fan through the third flange, and the fan is connected to the numerical control terminal.

5. A simulation test method for rock weathering in an extreme environment of Mars, the simulation test method being used for a simulation test of the simulation system for rock weathering in an extreme environment of Mars according to claim 1, wherein the simulation test method for rock weathering in an extreme environment of Mars comprises:
placing a sample on a storage tray inside the soil bin, covering a vacuum chamber cover, and monitoring the mass of the sample in real time through a pressure sensor; and opening a high-precision industrial camera to align with the sample;
opening a vacuum pump to stabilize air pressure in a vacuum chamber at 0.75 kPa, opening a CO₂ gas cylinder and a fan, and observing a CO₂ content monitored by the gas detector until the monitored CO₂ content is stably maintained at 95%; and then simultaneously opening an N₂ gas cylinder and a CH₄ gas cylinder, keeping the CO₂ content unchanged, and allowing an N₂ content to be 3% and a CH₄ content to be a trace amount, so as to simulate atmospheric composition on a surface of Mars;
opening a liquid nitrogen storage tank and a liquid nitrogen control valve to convey liquid nitrogen into a heat sink pipe, allowing a temperature in the vacuum chamber to reduce to −130° C.;
turning on an ultraviolet irradiation light source and a spectrometer, and controlling the spectrometer to adjust the irradiance of the ultraviolet irradiation light source, so as to simulate a situation that the surface of Mars is irradiated by Sun;
opening a high-pressure gas tank and a fifth control valve to allow a gas discharged from the high-pressure gas tank to carry out of silicon dioxide particles in a sand storage tank to form a dust-containing gas, and allow the dust-containing gas to pass through the fan to form a wind velocity field, so as to simulate a sand and dust phenomenon on the surface of Mars;
monitoring a flow velocity field in the vacuum chamber in real time through a PIV system; and
performing weathering characteristics assessment on the sample after a weathering simulation is completed.

6. The simulation test method for rock weathering in an extreme environment of Mars according to claim 5, wherein the simulation test method for rock weathering in an extreme environment of Mars further comprises: performing drying and CT scanning processing on the sample before performing the weathering simulation to obtain porosity no and density of the sample in an initial state, performing speckle spraying on a surface of the sample at the same time, ensuring uniform speckle distribution, and using the high-precision industrial camera to capture an initial picture of the sample.

7. The simulation test method for rock weathering in an extreme environment of Mars according to claim 6, wherein after the weathering simulation is completed, the weathering characteristics assessment of the sample comprises:
taking initial mass m₀ and final mass m₁ of the sample based on the mass of the sample monitored in real time by the pressure sensor, and
performing CT scanning on the sample after the weathering simulation is completed to obtain final porosity n₁ and density of the sample;
analyzing a displacement variation Δdᵢ of each speckle point on the surface of the sample after the weathering simulation is completed by using a distribution change of each speckle in the sample monitored in real time by the high-precision industrial camera presented by a numerical control terminal, combined with initial picture data of the sample, wherein i is an integer and ranges from 1 to 200;
calculating a mass loss rate Δm, a porosity change rate Δn and a surface deformation coefficient ε of the sample, wherein
the mass loss rate of the sample: Δm=(m₀−m₁)/m₀×100%,
the porosity change rate of the sample: Δn=(n₀−n₁)/n₀×100%, and
the surface deformation coefficient of the sample:
$$ε = \sqrt{{{Σ}_{i = 1}^{a} ( Δ {d}_{i} )}^{2} / a} ,$$
wherein Δdᵢ is a displacement variation of the i^{th} point of the surface of the sample, a is the number of speckles, and a=200; and
assigning a weight coefficient, taking a mass weight coefficient w₁ as 0.25, a porosity weight coefficient w₂ as 0.25, and a surface deformation weight coefficient w₃ as 0.5; and proposing a weathering index p, and p=w₁|Δm|+w₂|Δn|+w₃ε, wherein the larger p value indicates the higher degree of weathering of the sample in a rock weathering system in an extreme environment of Mars.
